(19) United States
(12) Patent Application Publication
(10) Pub. No.: US 2005/0001174 A1
(43) Pub. Date: Jan. 6, 2005

(54) Housing for receiving a light sensor and device for detecting of UV radiation

(75) Inventor: Peter Ueberall, Uetersen (DE)

Correspondence Address: PATENT ADMINSTRATOR;KATTEN MUCHIN ZAVIS ROSENMAN, 525 WEST MONROE STREET, SUITE 1600, CHICAGO, IL, 60661-3693, US

(73) Assignee: Trojan Technologies Inc.

(21) Appl. No.: 10/841,837

(22) Filed: May 10, 2004

(30) Foreign Application Priority Data
May 8, 2003 (DE) 103 20 807.0

(51) Int. Cl. G01J 5/00

(52) U.S. Cl. 250/372

(57) ABSTRACT

The invention relates to a device for detecting of an UV radiation as well as a housing which is part of the device and which receives a light sensor. The sensor housing comprises the following features: a wall which encloses the sensor; the wall comprises a region of incidence facing one or several UV radiation sources (1) as well as a region opposite to the UV radiation sources (1); at least the region of incidence consists of a material transparent to UV rays; the whole sensor housing (4) respectively the sensor housing (4) without the region opposite to the UV radiation source (1) is made of one single piece and free of openings.

### CROSS-REFERENCE TO RELATED APPLICATION

None.

### BACKGROUND OF THE INVENTION

1. Field of the Invention

The invention relates to the field of ultraviolet (UV) radiation.

The invention particularly relates to UV devices such as are used in the pharmaceutical industry. Such UV devices serve for disinfection of waste water. The sensors of the devices indicate the UV intensity (W/m²; mW/cm²). Further, such sensors monitor such UV devices for unacceptably low intensity, and trigger alarm, if necessary.

2. Description of the Prior Art

The conventional devices for detecting of UV rays comprise the said sensor as an essential component which is enclosed by a housing.

The whole device, particularly the sensor housing, has to meet various rigorous requirements. First, such a device has to perform its function—i.e., it has be able to detect the UV radiation reliably and precisely. Further, the device including each of its components should be of relatively simple design in order to minimize the cost of manufacture. Still further, the device should be relatively easy to assemble. Still further, the device should be relatively maintenance free. Still further, in the pharmaceutical industry cleanness of the parts involved is of great importance.

Conventional devices are disadvantageous since they only partly achieve these requirements.

### SUMMARY OF THE INVENTION

It is the object of the present invention to provide a novel device which obviates or mitigates the above-mentioned disadvantage of the prior art.

It is another object of the present invention to provide a device for detecting of UV radiation, and particularly the sensor housing thereof, which device, compared to the prior art: is of simple design, is easy to assemble, has low maintenance requirements, and may be kept clean over a long period of time, respectively, and has a low tendency of the development of germs.

Accordingly, in one of its aspects, the present invention provides a housing for receiving of an UV sensor comprising:
a wall which encloses the sensor;
the wall comprises a region of incidence facing one or several UV radiation sources (1) as well as a region opposite to the UV radiation sources (1);
at least the region of incidence consists of a material transparent to UV rays;
the whole sensor housing (4) respectively the sensor housing (4) without the region opposite to the UV radiation source (1) is made of one single piece and free of openings.

In another of its aspects, the present invention provides a device for the detection of an UV radiation comprising:
at least one UV radiation source (1);
a radiation chamber (3) enclosing the radiation source (1);
a sensor device with a sensor housing (4) the wall of which encloses a sensor;
the wall of the sensor housing (4) comprises a region of UV radiation incidence facing the UV radiation source (1) as well as a region opposite to the UV radiation source (1);
at least the region of incidence consists of a material which is transparent to UV radiation;
the whole sensor housing (4) respectively the sensor housing (4) without the region opposite to the UV radiation source (1) is made of one single piece and is free of openings.

The main idea of the invention consists in providing a sensor housing which is enclosed to a large extent, without perforations or openings, without quartz windows, O-rings, threaded treasurings, press fit stuffings or sealing means. Preferably, the wall is made of one single piece (i.e., it is of unitary construction). Preferably, it is made by casting or by die forging or by machining such as turning on a lathe. In particular, the wall is closed on that side which faces the UV radiation source.

Further, it is important to provide an UV transparent material for the sensor housing, such as Teflon or similar materials or glass. At least that region of the wall should consist of such a material which a faces the UV radiation source (region of incidence).

There is no need for disassembling an undivided and totally closed sensor housing of the said type for sanitizing of the UV device by means of steam or hot water, which reduces the costs of maintenance as well as the risk of re-germination. Further, due to the absence of quartz windows or the like there is no deterioration by extreme temperature variations and/or by leakages.

### BRIEF DESCRIPTION OF THE DRAWINGS

Embodiments of the present invention will be described with reference to the accompanying drawings, wherein like reference numerals denote like parts, and in which:

FIGS. 1-3 each illustrate a sectional view of various embodiments of the present invention.

### DETAILED DESCRIPTION OF THE PREFERRED EMBODIMENTS

Embodiments of the invention are explained more in detail with reference to the drawings, showing diagrammatically embodiments of the invention.

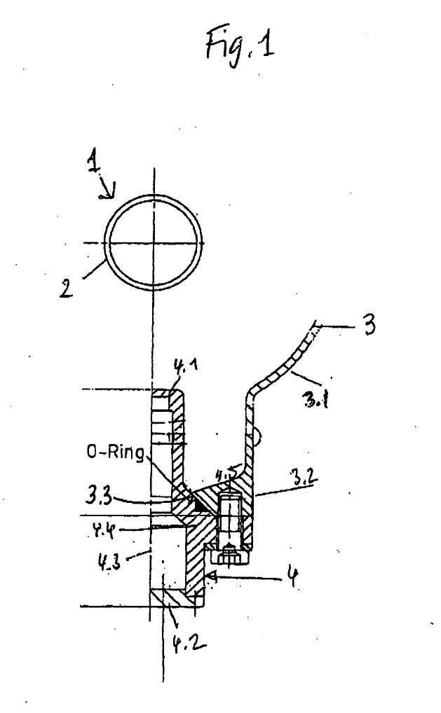

With reference to FIG. 1, there is illustrated a radiation source 1 enclosed by an enveloping tube 2.

The enveloping tube is housed in a radiation chamber 3. Radiation chamber 3 comprises a chamber wall 3.1. The chamber wall in its lower portion comprises a connecting flange 3.2 which is provided with a conical face 3.3, forming a seat.

A sensor housing 4 is connected to the chamber wall 3.1 of the radiation chamber 3. Sensor housing 4 surrounds a sensor (not shown). The sensor receives the radiation from a radiation source 1.

The sensor housing 4 comprises a main portion 4.1 and a cover 4.2. Main portion 4.1 consists of a material that is non-transparent with respect to UV-radiation. An example of such a material is Teflon™. Sensor housing 4 essentially is of cylindrical shape. In the embodiment shown, it consists of an upper, relatively long cylinder and a lower, relatively short cylinder. The axes 4.3 of both cylinders in general pass through radiation source 1.

A UV device may comprise one or several UV radiation sources, located in the center according to specific patterns and arranged concentrically.

Main portion 4.1 of sensor housing 4 consists of one single piece (i.e., unitary construction). The wall is completely closed, also at the end face (region of incidence), facing radiation source 1.

Cover 4.2 in the present case is made of Teflon™. It may, however, be made of any other material which is transparent UV radiation. Cover 4.2 mechanically is fixedly connected to main portion 4.1—e.g., by screws, or by press fitting or by shrink fitting. Cover 4.2 permits the assembly of the sensor as well as of an amplifier. The sensor cable may be past through cover 4.1 by means of a thread nipple. Instead, it may be lead out of the housing at a site thereof.

Main portion 4.1 is provided with a circumferential flange 4.4. Circumferential flange 4.4 comprises a seat 4.5 complementary to seat 2.3 of connecting flange 3.2 of chamber wall 3.1. Assembling is very easy by means of the said seats 3.3, 4.5. Sensor housing 4 when being inserted into the opening of chamber wall 3.1 will get centered automatically.

As may be seen, both parts, chamber wall 3.1 and main portion 4.1 of sensor housing 4, are fixedly connected to each other by screws. Also, there is provided a seal ring at face 4.5. Such seal ring also may be inserted in connecting flange 3.2 of chamber wall 3.1.

Accordingly, the interior of sensor housing 4 is hermetically sealed with respect to the environment. Normally, the interior of sensor housing 4 in addition to the sensor houses an amplifier.

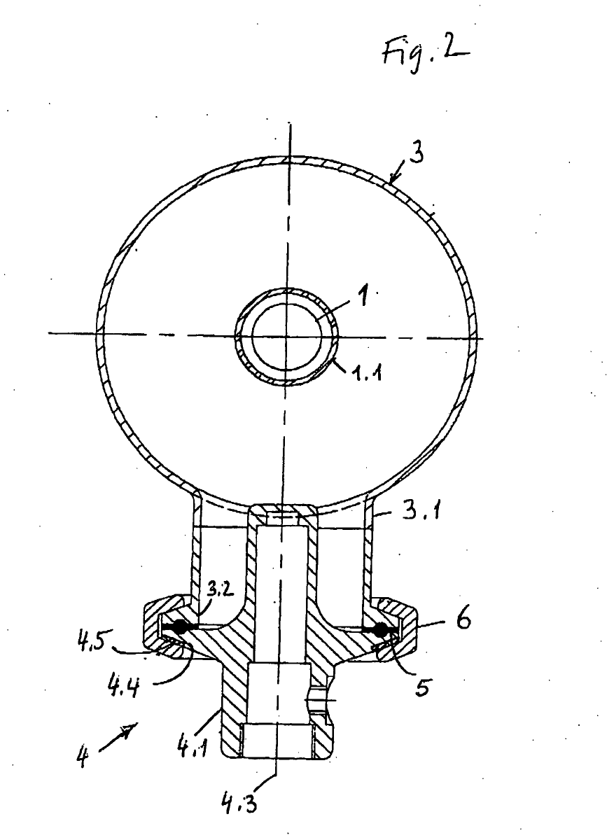

Also with the embodiment according to FIG. 2 there is a radiation source 1. Radiation source 1 is enclosed by an enveloping tube 1.1 made of quartz. Radiation source 1 and enveloping tube 1.1 are located inside of a radiation chamber 3 comprising a chamber wall 3.1. A sensor housing 4 is connected to chamber wall 3.1 as is described by the following.

Chamber wall 3.1 again comprises a connecting flange 3.2.

Sensor housing 4 comprises a main portion 4.1 as well as a plug, not shown, which may be connected with main portion 4.1 by threading.

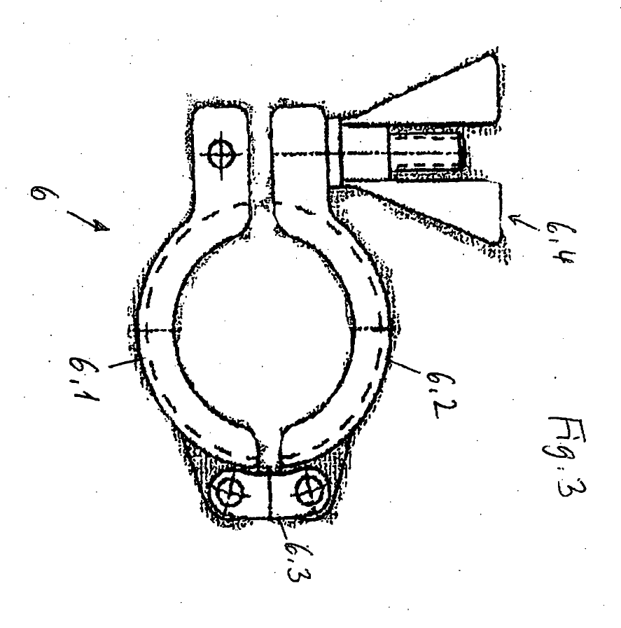

Main portion 4.1 of sensor housing 4 comprises a circumferential flange 4.4 which may bear a reinforcing conical metal disc 4.5. Both flanges 3.2 and 4.4 also comprise faces neighbouring each other between which there is provided a seal ring 5. Both flanges 3.2 and 4.4 with the sandwiched seal ring are clamped by means of a clamping device 6—see FIG. 3.

Sensor housing 4 again is of cylindrical shape. The cylinder access 4.3 is directed to the center of the radiation chamber 3, and therefore also to the centres of radiation source 1 and of enveloping tube 1.1. Here again it is possible to provide two or more UV radiators.

Radiation source 1, enveloping tube 1.1 and radiation chamber 3 accordingly are arranged concentrically with respect to each other.

Clamp 6 as shown in FIG. 3 comprises two portions 6.1, 6.2 which are linked together by means of a linking shackle 6.3. There is provided a screw connection 6.4 comprising a wing screw for tightening of clamp 6.

As may be seen from the illustrated embodiments, the sensor housing 4 is free of joints, indentations, gabs, and particularly free of screw connections which, if present, would attract and/or collect dirt and germs. Such risk would otherwise particularly be present with screws. The connection between the radiation chamber 3 and the sensor housing 4 is made by clamping.

With both embodiments according to FIGS. 1 and 2, the sensor housing is located below the radiation source 3. However, this might be arranged otherwise. For example, it could be advantageous to locate sensor housing 4 above radiation chamber, but also at a site thereof—i.e., in the three o'clock or in the nine o'clock position relative to radiation chamber 3.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

1. A housing for receiving of an UV sensor comprising:
a wall which encloses the sensor;
the wall comprises a region of incidence facing one or several UV radiation sources (1) as well as a region opposite to the UV radiation sources (1);
at least the region of incidence consists of a material transparent to UV rays;
the whole sensor housing (4) respectively the sensor housing (4) without the region opposite to the UV radiation source (1) is made of one single piece and free of openings.

2. The housing defined in claim 1, wherein the wall consists of a main portion (4.1) comprising the region of incidence, further of a covering portion (4.2) which mechanically is connectable to the main portion (4.1) and which comprises the region opposed to the UV radiation source (1).

3. The housing defined in claim 1, wherein (i) the wall of the sensor housing is in the form of a cylinder or of several cylinders one behind the other one; and (ii) the axes (4.3) of the cylinders pass through the UV radiation source (1).

4. The housing defined in claim 1, wherein the wall of the sensor housing (4) comprises a circumferential flange which has a seat (4.5).

5. The housing defined in claim 4, wherein the seat (4.5) is of conical shape.

6. The housing according to claim 1, wherein the wall is made by casting or by pressing or by turning.

7. A device for the detection of an UV radiation comprising:
at least one UV radiation source (1);
a radiation chamber (3) enclosing the radiation source (1);
a sensor device with a sensor housing (4) the wall of which encloses a sensor;
the wall of the sensor housing (4) comprises a region of UV radiation incidence facing the UV radiation source (1) as well as a region opposite to the UV radiation source (1);
at least the region of incidence consists of a material which is transparent to UV radiation;
the whole sensor housing (4) respectively the sensor housing (4) without the region opposite to the UV radiation source (1) is made of one single piece and is free of openings.

8. The device defined in claim 7, wherein the wall of the sensor housing (4) comprises a main portion (4.1) which comprises the region of incidence, further a cover portion (4.2) which mechanically is connectable with the main portion (4.1) and which comprises the region opposite to the UV radiation source (1).

9. The device defined in claim 7, wherein (i) the wall of the sensor housing (4) has the shape of a cylinder or of several cylinders arranged one after the other; and (ii) the axes (4.3) of the cylinders are directed to the UV radiation source (1).

10. The device defined in claim 7, wherein the wall of the sensor housing (4) comprises a circumferential flange (4.4) which has a seat (4.5).

11. The device defined in claim 7, wherein the seat (4.5) is of conical shape.

12. The device defined in claim 11, wherein the chamber wall (3.1) of the radiation chamber (3) comprises a connecting flange (3.2) with a seat (3.3) which is complementary to the seat (4.5) of the circumferential flange (4.4) of the wall of the sensor housing (4).
